(19) United States
(12) Patent Application Publication
(10) Pub. No.: US 2007/0145716 A1
(43) Pub. Date: Jun. 28, 2007

(54) PINTLE HOOK AND BALL HITCH ASSEMBLY SHOCK ABSORBER

(76) Inventor: Todd Schulze, Mooresville, NC (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/679,243

(22) Filed: Feb. 27, 2007

Related U.S. Application Data
(63) Continuation-in-part of application No. 11/270,847, filed on Nov. 9, 2005.

(51) Int. Cl. B60D 1/50

(52) U.S. Cl. 280/483

(57) ABSTRACT

The use of a shock absorber bushing combination to accommodate various size ball ands and tow rings when towing large heavy industrial trailers. The shock absorber bushing combination can be cylindrically-shaped and adapted to have an interior hollow dimension to easily slide over the ball. Its length is adapted to extend at least to a height above the centerline of the ball and preferably so its top surface is aligned relatively close to the height of the ball. On or more if the shock absorber bushings has a flanged portion at its bottom side that is dimensioned in thickness and width to provide some vertical movement shock absorbing effect due to the action of the tow ring bouncing up and down when hitting bumps in the road surface.

### RELATED APPLICATION

This application is a continuation-in-part of U.S. patent application Ser. No. 11/270,847 filed Nov. 9, 2006.

### FIELD OF THE INVENTION

The invention relates to the shock absorbing of a pintle hook and hitch ball assembly used to tow trailers, typically having a gross trailer weight (GWT) of about 10,000 pounds and higher.

### BACKGROUND OF THE INVENTION

Current pintle hook assemblies allow for relatively extreme jarring and shock to drivers and passengers in tow vehicles, especially when the brakes are applied or when the vehicle is placed in motion. Typically, the tow ring gap around the ball is the problem. When a tow vehicle has to brake suddenly, the tow ring connected to the trailer slides forward and slams against one side of the ball and pintle hook assembly. When the tow vehicle accelerates, the tow ring then slides away from the ball and pintle hook assembly and slams against the opposite side of the ball. The result is a whip lash effect to the individuals inside the tow vehicle cab.

The purpose of the present invention is to provide a shock absorbing device and method to prevent or substantially reduce the whip lashing caused by the sliding of the tow ring back and forth against the ball whenever braking or accelerating occurs.

### SUMMARY OF THE INVENTION

As a general application, the present invention is anticipated to be applied to trailing devices using tow rings and pintle hooks. These systems are usually found where the trailer GTW may be 10,000 pounds and higher.

The present invention involves the use of a shock absorber bushing around the ball and between the ball and tow ring. The shock absorber bushing can be cylindrically-shaped and adapted to have an interior hollow dimension to easily slide over the ball. Its length is configured to extend at least to a height above the centerline of the ball and preferably so its top surface is aligned relatively close to the height of the ball. In a preferred embodiment, the shock absorber bushing has a flanged portion at its bottom side that is dimensioned in thickness and width to provide some vertical movement shock absorbing effect due to the action of the tow ring bouncing up and down when hitting bumps in the road surface.

The shock absorbing system can be made from materials suitable to withstand the significant lateral compressive forces exerted by the tow ring on the ball within the pintle hook of the downward vertical forces on the pintle hook lower half, without permanently deforming and cracking the bushing. For example, one type of suitable material is a vulcanized rubber and/or plastic based material. The material used to make hockey pucks provides for a vulcanized rubber material that can withstand significant impact compressive forces. Material having similar characteristics would be suitable for use as a shock absorber. That is, the bushing effectively has to have characteristics where its elastic deformation, its pliancy, and its overall elasticity, strength and stability are suitable for be subjected to such harsh forces. In addition, fiber reinforced or meshed composites made of plastic or polymer based materials, rubber materials and combinations thereof similar to the materials used in the automotive industry and aircraft industry are other examples of anticipated suitable materials. The material must also have bearing characteristics that would allow for the easy rotation of the ball within the interior of the shock absorber when the tow vehicle is turning. Given these characteristics, one skilled in the art can produce a variety of composite materials from polymer/plastic material, vulcanized rubber materials or combinations thereof to form the shock absorber bushing with well known materials.

### BRIEF DECSRIPTION OF THE DRAWINGS

In the accompanying drawings:

FIG.1 is a perspective conceptual view of a pintle hook trailering assembly with one embodiment of the present invention installed;

FIG. 2 is a perspective partial cross-section view depicting the embodiment being used in FIG. 1; and

FIG. 3A is a perspective view of the present invention bushing used in FIG. 1;

FIG. 3B is a perspective view of an alternative embodiment of the present invention bushing; and

FIG. 4 is a perspective view of an alternative embodiment using two or more bushings to accommodate various size balls and tow rings.

### DETAILED DESCRIPTION OF THE INVENTION

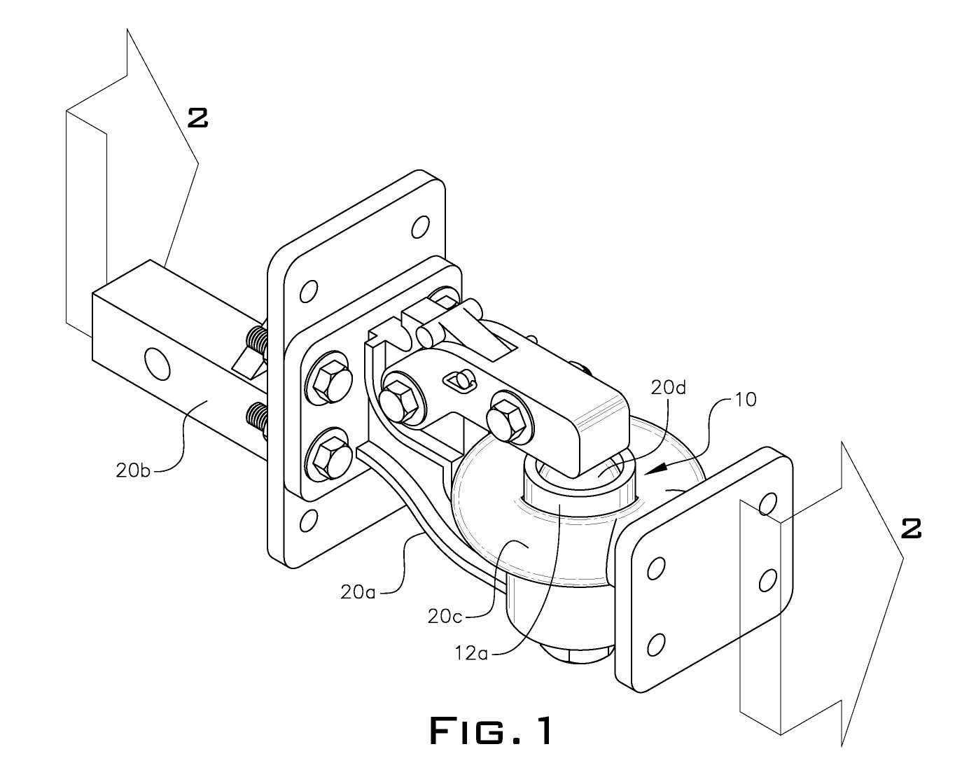

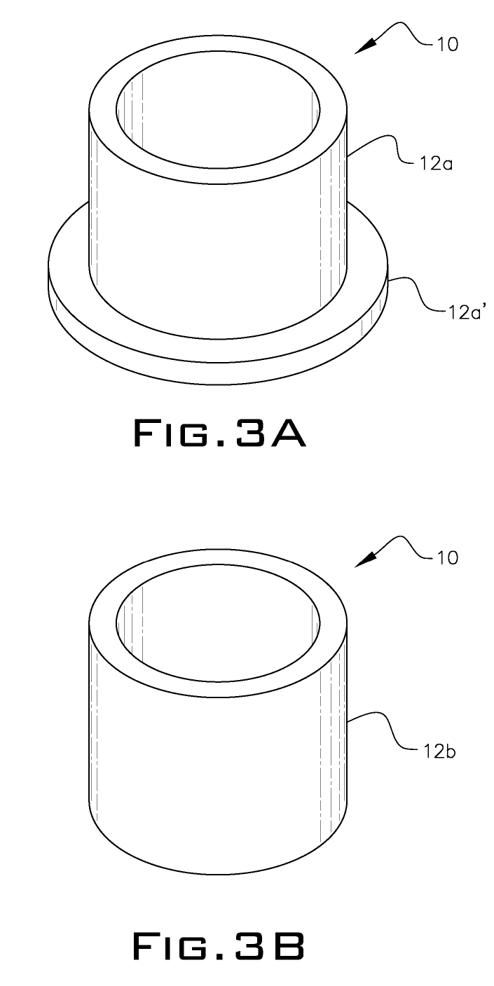

Referring now to the drawings, FIGS. 1-2 and 3A-3B disclose the present invention, which is a pintle hook and ball assembly shock absorber and is depicted generally as 10.

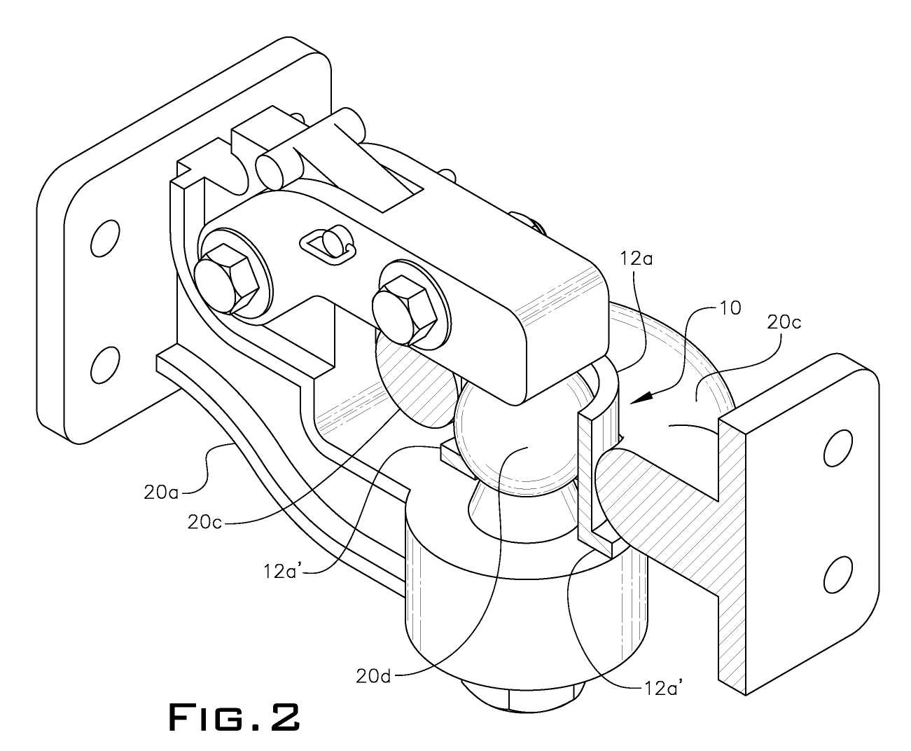

In FIGS. 1-2, the pintle hook 20a is shown connected to pintle hook mounting plate 20b, which is connected to the tow vehicle (not shown). The trailer ball hitch or ball 20d is attached to the bottom portion of the pintle hook 20a. When attaching a trailer for towing, the upper half of the pintle hook 20a has a portion that pivots away to all for the tow ring 20c to be installed over and around the ball 20d, then the upper half is re-positioned to lock the tow ring 20c in place for towing.

As can be viewed in the drawing, the present invention 10 (bushing 12a or bushing 12b) is first placed around the ball. If the bushing has a flanged portion 12a′ such as that depicted in FIGS. 1-2 and 3A, the flanged portion 12a′ is preferably placed against the bottom half of the pintle hook 20a.

The overall diameter of the cylindrical portion of the bushing 12a,12b should be sized so as to minimize the back and forth movement of the tow ring 20c, yet have sufficient tolerance to allow easy turning of the ball 20d relative to the inside of the bushing 12a,12b when turns are being made by the tow vehicle.

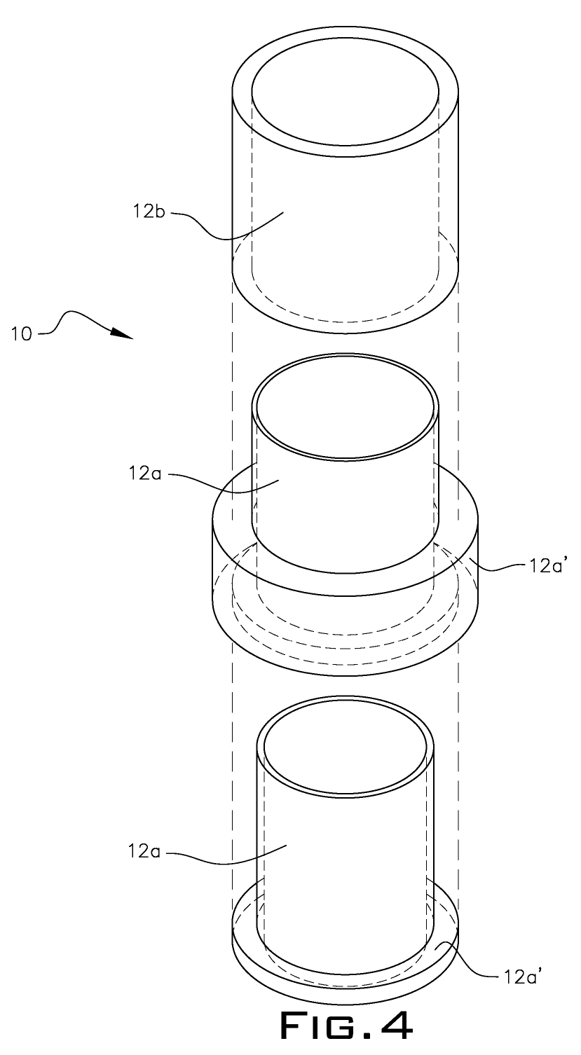

In an alternative embodiment, which will allow for flexibility when confronted with different size tow rings 20c and balls 20d, two or more bushings 12a,12b may be used as depicted conceptually in FIG. 4. This figure depicts a combination pintle puck. By using the variations of these pieces, it enables you to fit over the a 2 inch or a 2 5/16 inch ball and enables you to pull a 2½ or 3 inch ring inside diameter. Assume for purpose of illustration that the upper depicted bushing has an outside dimension of 2⅞ inch and a wall thickness of ¼, the intermediate depicted bushing has an inside diameter of 2⅜ inch and an outside cylindrical diameter of 2 7/16 inch, and the lower bushing has an inside diameter of 2 1/16 and is sized to snuggly fit into the intermediate the bushing. Now assuming the intermediate flanged bushing 12a is the main body and it alone fits over a 2 5/16 inch ball and accepts a 2½ inch ring. By placing the upper depicted bushing 12b over the top of the intermediate bushing 12a, the combination now accepts a 2 5/16 inch ball and a 3 inch ring. Alternatively, by placing the lower depicted bushing 12a which is smaller size than the main intermediate bushing, the combination is now enabled to accept a 2 inch ball. Accordingly, one can see that all three bushings may be combined or the upper bushing and the intermediate bushing may be combined and alternatively, the intermediate and the lower bushing may be combined depending the available sizes of the ball and tow ring.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A method of minimizing the whip lash effect to individuals in a tow vehicle towing a trailer using a pintle hook attached to the tow vehicle, a ball mounted within the pintle hook and tow ring attached to the trailer being towed comprising:
using a combination of concentric shock bushings adapted to accommodate a placement of an inner bushing around a ball mounted within the pintle hook and the outer bushing adapted to accommodate an inside diameter of a tow ring.

2. The method according to claim 1, wherein said combination of concentric shock absorber bushings is one of:
a first bushing being cylindrically-shaped with a hollow interior and a second generally cylindrically-shaped bushing having a flanged portion at its lower end, wherein the first bushing is sized to slide over the second bushing such that the combination of said first and second bushing forms a combined shock absorber sized with tolerance between the ball and bushing to allow for easy turning of the ball relative to the combined shock absorber when turns are being made by the tow vehicle and allows for said tow ring to slide over the combined shock absorber, or
said second generally cylindrically-shaped bushing with said flanged portion at its lower end and third generally cylindrically-shaped bushing with a flanged portion at its lower end, wherein said third generally cylindrically-shaped bushing is sized to slide into said second generally cylindrically-shaped bushing such that the combination of said second and third bushings forms a combined shock absorber sized with tolerance between the ball and bushing to allow for easy turning of the ball relative to the combined shock absorber when turns are being made by the tow vehicle and allows for said tow ring to slide over the combined shock absorber, or
said first generally cylindrically-shaped bushing with said hollow interior and said second generally cylindrically-shaped bushing having said flanged portion at its lower end, wherein said first bushing is sized to slide over said second bushing, and said third generally cylindrically-shaped bushing with said flanged portion at its lower end, wherein said third generally cylindrically-shaped bushing is sized to slide into said generally cylindrically-shaped bushing such that the combination of said first, second and third bushings forms a combined shock absorber sized with a tolerance between the ball and bushing to allow for easy turning of the ball relative to the combined shock absorber when turns are being made by the tow vehicle and allows for said tow ring to slide over the combined shock absorber,
wherein any of said combinations has an overall cylindrical diameter sized so as to minimize a back and forth movement of the tow ring within the pintle hook.

3. The method according to claim 1, wherein said shock absorber bushings are made from material comprising polymer-based material, plastic-based material, rubber-based material or any combination thereof.

4. A shock absorber for minimizing the whip lash effect to individuals in a tow vehicle towing a trailer using a pintle hook attached to the tow vehicle, a ball mounted within the pintle hook and tow ting attached to the trailer being towed comprising:
a combination of concentric shock absorber bushings adapted to accommodate a placement of an inner bushing around a ball mounted within the pintle hook and the outer bushing adapted to accommodate an inside diameter of a tow ring.

5. The shock absorber according to claim 4, wherein said combination of concentric shock absorber bushings is one of:
a first bushing being generally cylindrically-shaped with a hollow interior and a second generally cylindrically-shaped bushing having a flanged portion at its lower end, wherein the first bushing is sized to slide over the second bushing such that the combination of said first and second bushings forms a combined shock absorber sized with a tolerance between the ball and bushing to allow for easy turning of the ball relative to the combined shock absorber when turns are being made by the tow vehicle and allows for said tow ring to slide over the combined shock absorber, or
said generally cylindrically-shaped bushing with said flanged portion at its lower end and a third generally cylindrically-shaped bushing with a flanged portion at its lower end, wherein said third generally cylindrically-shaped bushing is sized to slide into said second generally cylindrically-shaped bushing such that the combination of said second and third bushings forms a combined shock absorber sized with a tolerance between the ball and bushing to allow for easy turning of the ball relative to the combined shock absorber when turns are being made by the tow vehicle and allows for said tow ring to slide over the combined shock absorber, or
said first generally cylindrically-shaped bushing with said hollow interior and said second generally cylindrically-shaped bushing having said flanged portion at its lower end, wherein said first bushing is sized to slide over said second bushing, and said third generally cylindrically-shaped bushing with said flanged portion at its lower end, wherein said third generally cylindrically-shaped bushing is sized to slide into said second generally cylindrically-shaped bushing such that the combination of said first, second and third bushings forms a combined shock absorber sized with a tolerance between the ball and bushing to allow for easy turning of the ball relative to the combined shock absorber when turns are being made by the tow vehicle and allows for said tow ring to slide over the combined shock absorber,
wherein any of said combinations has an overall cylindrical diameter sized so as to minimize a back and forth movement of the tow ring within the pintle hook.

5. The shock absorber according to claim 4, wherein the bushing is made from material comprising polymer-based material, plastic-based material, rubber-based material or any combination thereof.
